(19) United States
(12) Patent Application Publication
(10) Pub. No.: US 2013/0164505 A1
(43) Pub. Date: Jun. 27, 2013

(54) Purple Solder Proof Ink Composition, Purple Printed Circuit Board and Process for Preparing the Same

(71) Applicants: Peking University Founder Group Co., Ltd., Beijing (CN); Chongqing Founder Hi-Tech Electronic Inc., Chongqing (CN)

(72) Inventors: Shikong WU, Chongqing (CN); Wenjing LIU, Chongqing (CN)

(73) Assignees: CHONGQING FOUNDER HI-TECH ELECTRONIC INC., Chongqing (CN); PEKING UNIVERSITY FOUNDER GROUP CO., LTD., Beijing (CN)

(21) Appl. No.: 13/725,834

(22) Filed: Dec. 21, 2012

(30) Foreign Application Priority Data
Dec. 21, 2011 (CN) 201110435702.9

(51) Int. Cl. C09D 11/10

(52) U.S. Cl. 428/195.1; 524/1; 427/96.1

(57) ABSTRACT

Disclosed are a purple solder proof ink composition for printing circuit board, a process for preparing a purple printed circuit board, and a purple printed circuit board.

### RELATED APPLICATIONS

This application claims priority to Application No. 201110435702.9 filed with the State Intellectual Property Office of China on Dec. 21, 2011, the content of which is incorporated herein by reference in its entirety.

### FIELD

The disclosure relates to the field of printed circuit board (PCB), such as a purple solder proof ink composition for printing circuit board, a purple printed circuit board, and a process for preparing a purple printed circuit board.

### BACKGROUND

Solder proof inks have been used in the manufacturing process of PCB. However, the colors for solder proof inks can be only green, white, red, and black. Thus, color ranges selected for solder proof inks are limited. There exists a need for a solder proof ink and circuit boards in other colors to meet customers' individual requirements.

### SUMMARY

In one aspect, disclosed is a purple solder proof ink composition for printing a circuit board, comprising a white solder proof ink, a red solder proof ink, and a black solder proof ink in a weight ratio of, for example, 0.9-1.1:0.9-1.1:0.9-1.1 (i.e., white solder proof ink: red solder proof ink: black solder proof ink).

In another aspect, disclosed is a process for preparing a purple printed circuit board, comprising: (1) mixing a white solder proof ink, a red solder proof ink, and a black solder proof ink in a weight ratio of 0.9-1.1:0.9-1.1:0.9-1.1 to prepare a purple solder proof ink composition; (2) adding at least one curing agent to the purple solder proof ink composition; and (3) printing the purple solder proof ink composition comprising the white solder proof ink, the red solder proof ink, the black solder proof ink, and the at least one curing agent on at least one side of the circuit board.

In yet another aspect, disclosed is a purple printed circuit board, printed with a purple solder proof ink composition, wherein the purple solder proof ink composition comprises a white solder proof ink, a red solder proof ink, and a black solder proof ink in a weight ratio of 0.9-1.1:0.9-1.1:0.9-1.1.

### DETAILED DESCRIPTION

### Definition

Except as otherwise indicated in this disclosure, the expressions “comprise” and “include” should be understood to be open-ended, i.e. “including but not limited to”.

The term in this disclosure “solder proof ink” refers to an ink composition printed on the circuit board for preventing solder from bridging between conductors, thereby preventing short circuits.

The term in this disclosure “curing agent,” also referred as “hardening agent” and “stiffening agent,” refers to a compound or composition for promoting or controlling a curing reaction. For example, the curing of a solder proof ink is a process in which a thermosetting resin is irreversibly modified by chemical reactions such as condensation, ring-closure reaction, addition and/or catalysis reaction, and the curing is achieved by adding at least one curing agent to effect crosslinking of the resin.

The term in this disclosure “diluent” refers to an agent for diluting a purple solder proof ink composition in order to modify the viscosity thereof.

### Embodiments

In one aspect, disclosed is a purple solder proof ink composition for printing a circuit board, comprising a white solder proof ink, a red solder proof ink, and a black solder proof ink in a weight ratio of 0.9-1.1:0.9-1.1:0.9-1.1.

In some embodiments, the purple solder proof ink composition may further comprise at least one curing agent.

In some embodiments, the purple solder proof ink composition may further comprise at least one diluent.

In some embodiments, the purple solder proof ink composition comprises a white solder proof ink, a red solder proof ink, and a black solder proof ink in a weight ratio of 0.9:1:1.

In some embodiments, the purple solder proof ink composition comprises a white solder proof ink, a red solder proof ink, and a black solder proof ink in a weight ratio of 1:0.9:1.

In some embodiments, the purple solder proof ink composition comprises a white solder proof ink, a red solder proof ink, and a black solder proof ink in a weight ratio of 1:1:0.9.

In some embodiments, the purple solder proof ink composition comprises a white solder proof ink, a red solder proof ink, and a black solder proof ink in a weight ratio of 0.9:0.9:1.

In some embodiments, the purple solder proof ink composition comprises a white solder proof ink, a red solder proof ink, and a black solder proof ink in a weight ratio of 1:0.9:0.9.

In some embodiments, the purple solder proof ink composition comprises a white solder proof ink, a red solder proof ink, and a black solder proof ink in a weight ratio of 0.9:1:0.9.

In some embodiments, the purple solder proof ink composition comprises a white solder proof ink, a red solder proof ink, and a black solder proof ink in a weight ratio of 1:1:1.

In some embodiments, the purple solder proof ink composition comprises a white solder proof ink, a red solder proof ink, and a black solder proof ink in a weight ratio of 0.9:0.9:0.9.

In some embodiments, the purple solder proof ink composition comprises a white solder proof ink, a red solder proof ink, and a black solder proof ink in a weight ratio of 0.95:1.05:0.95.

In some embodiments, the purple solder proof ink composition exhibits a color of Nos. 89-93 in CMYK color model chart.

In some embodiments, the purple solder proof ink composition exhibits a color of Nos. 90-92 in CMYK color model chart.

In some embodiments, the purple solder proof ink composition exhibits a color of No. 91 in CMYK color model chart.

In another aspect, disclosed is a process for preparing a purple printed circuit board, comprising:
(1) mixing a white solder proof ink, a red solder proof ink, and a black solder proof ink in a weight ratio of 0.9-1.1:0.9-1.1:0.9-1.1 to prepare a purple solder proof ink composition;
(2) adding at least one curing agent to the purple solder proof ink composition; and
(3) printing the purple solder proof ink composition comprising the white solder proof ink, the red solder proof ink, the black solder proof ink, and the at least one curing agent on at least one side of the circuit board.

Exemplary curing agents in the disclosure include, but are not limited to, a thermocuring curing agent, such as dicyandiamide (DICY), dimethylaminopropylamine (DMAPA), diethylaminopropylamine (DEAPA), and the like.

In some embodiments, the process for preparing a purple printed circuit board further comprises adding at least one diluent to the purple solder proof ink composition. Thus, the purple solder proof ink composition used in the printing step may comprise the white solder proof ink, the red solder proof ink, the black solder proof ink, optionally the at least one diluent, and the at least one curing agent.

Exemplary diluents for dissolving a purple solder proof ink composition in the disclosure include, but are not limited to, butanone, cyclohexanone, benzene, toluene, and the like. In accordance with requirements of a preparing process for the printed circuit board, the boiling point (evaporating point) of the diluent can range from 40° C. to 70° C.

In some embodiments, the mixture comprising the white solder proof ink, the red solder proof ink, the black solder proof ink, the at least one curing agent, and the optional at least one diluent is stirred until viscosity of the mixture ranges from 130 to 180 dps before the printing step.

In some embodiments, the weight ratio of the combination of the white solder proof ink, the red solder proof ink, and the black solder proof ink to the at least one curing agent is 3-4:1.

In some embodiments, the weight to volume ratio of the combination of the white solder proof ink, the red solder proof ink, and the black solder proof ink to the at least one diluent is 1kg:15-20 mL.

In yet another aspect, disclosed is a purple printed circuit board, printed with a purple solder proof ink composition, the purple solder proof ink composition comprises a white solder proof ink, a red solder proof ink, and a black solder proof ink in a weight ratio of 0.9-1.1:0.9-1.1:0.9-1.1.

Additionally, note that although each of the different embodiments herein may be discussed in different places of this disclosure, it is intended, where appropriate, that each of the embodiments can optionally be executed independently of each other or in combination with each other to provide various modifications. Such variations are intended to be within the scope of this present disclosure.

The following examples are intended for illustration of the disclosure only without limiting the scope thereof.

### EXAMPLES

### Preparation of a Purple Solder Proof Ink Composition

The solder proof inks used in the disclosure are commercially available from TAIYO INK, Series PSR-2000. For example, the white solder proof ink is of PSR-2000 WT500, the red solder proof ink is of PSR-2000 RD500, and the black solder proof ink is of PSR-2000 E.

### Example 1

The white solder proof ink, the red solder proof ink, and the black solder proof ink, in a weight ratio of 0.9:1:1, were mixed with stirring until homogeneity is achieved to the extent that there was no color aberration. A purple solder proof ink composition was thus obtained.

### Example 2

The white solder proof ink, the red solder proof ink, and the black solder proof ink, in a weight ratio of 1:0.9:1, were mixed, and a diluent was then added (the weight to volume ratio of the combination of the white solder proof ink, red solder proof ink, and black solder proof ink to the diluent was 1 kg:15 mL). The mixture was stirred until homogeneity was obtained to the extent that there was no color aberration. A purple solder proof ink composition was thus obtained.

### Example 3

The white solder proof ink, the red solder proof ink, and the black solder proof ink were mixed in a weight ratio of 1:1:0.9. A curing agent was added to the mixture (the weight ratio of the combination of the white solder proof ink, the red solder proof ink, and the black solder proof ink to the curing agent is 3.5:1). The mixture was stirred until homogeneity was obtained to the extent that there was no color aberration. A purple solder proof ink composition was thus obtained.

### Example 4

The white solder proof ink, the red solder proof ink, and the black solder proof ink were mixed in a weight ratio of 0.9:0.9:1. A curing agent was added to the mixture (the weight ratio of the combination of the white solder proof ink, the red solder proof ink, and the black solder proof ink to the curing agent was 3:1), and then a diluent was added (the weight to volume ratio of the combination of the white solder proof ink, the red solder proof ink, and the black solder proof ink to the diluent is 1 kg:15 mL). The mixture was stirred until homogeneity was obtained to the extent that there was no color aberration. A purple solder proof ink composition was obtained.

### Example 5

The white solder proof ink, the red solder proof ink, and the black solder proof ink were mixed in a weight ratio of 1:0.9:0.9. A curing agent was added to the mixture (the weight ratio of the combination of the white solder proof ink, the red solder proof ink, and the black solder proof ink to the curing agent was 3:1), and then a diluent was added (the weight to volume ratio of the combination of the white solder proof ink, the red solder proof ink, and black solder proof ink to the diluent is 1 kg:15 mL). The mixture was stirred until homogeneity was obtained to the extent that there was no color aberration. A purple solder proof ink composition was obtained.

### Example 6

The white solder proof ink, the red solder proof ink, and the black solder proof ink were mixed in a weight ratio of 0.9:1:0.9. A curing agent was added to the mixture (the weight ratio of the combination of the white solder proof ink, the red solder proof ink, and the black solder proof ink to curing agent was 3:1), and then a diluent was added (the weight to volume ratio of the combination of the white solder proof ink, the red solder proof ink, and the black solder proof ink to the diluent was 1 kg:20 mL). The mixture was stirred until homogeneity was obtained to the extent that there was no color aberration. A purple solder proof ink composition was thus obtained.

### Example 7

The white solder proof ink, the red solder proof ink, and the black solder proof ink were mixed in a weight ratio of 1:1:1. A curing agent was added to the mixture (the weight ratio of the combination of the white solder proof ink, the red solder proof ink, and the black solder proof ink to curing agent was 4:1), and then a diluent was added (the weight to volume ratio of the combination of the white solder proof ink, the red solder proof ink, and the black solder proof ink to the diluent was 1 kg:20 mL). The mixture was stirred until there was no color aberration. A purple solder proof ink composition was thus obtained.

### Example 8

The white solder proof ink, the red solder proof ink, and the black solder proof ink were mixed in a weight ratio of 0.9:0.9:0.9. A curing agent was added to the mixture (the ratio of the combination of the white solder proof ink, the red solder proof ink, and the black solder proof ink to curing agent was 3:1), and then a diluent was added (the weight to volume ratio of the combination of the white solder proof ink, the red solder proof ink, and the black solder proof ink to the diluent was 1 kg:20 mL). The mixture was stirred until homogeneity was obtained to the extent that there was no color aberration. A purple solder proof ink composition was thus obtained.

### Example 9

The white solder proof ink, the red solder proof ink, and the black solder proof ink were mixed in a weight ratio of 0.95:1.05:0.95. A curing agent was added to the mixture (the weight ratio of the combination of the white solder proof ink, the red solder proof ink, and the black solder proof ink to the curing agent was 3.5:1), and then a diluent was added (the weight to volume ratio of the combination of the white solder proof ink, the red solder proof ink, and the black solder proof ink to the diluent was 1 kg:17 mL). The mixture was stirred until homogeneity was obtained to the extent that there was no color aberration. A purple solder proof ink composition was obtained.

In the above examples, the mixtures were mixed by mechanical stirring with a stirring rate of 35+/−5 rpm and a stirring period of 15 min until no color aberration was observed or by hand mixing for 5 min until no color aberration was observed and subsequently by mechanical stirring.

The viscosities were determined at least 15 minutes, but no more than 1 hour, after the mixing.

The colors and viscosities of the solder proof ink compositions prepared in Examples 1-9 are shown in Table 1.

TABLE 1

| | The weight ratio of the | Weight ratio of | Weight to volume ratio | Viscosity of the solder | |
|---|---|---|---|---|---|
| | white, red, and black | the added curing | of the added diluent | proof ink composition | Color of the solder |
| Example | solder proof ink | agent¹ | (kg:mL)² | (dps) | proof ink composition |
| 1 | 0.9:1:1 | No curing agent | No diluent | 178 | purple |
| 2 | 1:0.9:1 | No curing agent | 1:15 | 168 | purple |
| 3 | 1:1:0.9 | 3.5:1 | No diluent | 171 | purple |
| 4 | 0.9:0.9:1 | 3:1 | 1:15 | 163 | purple |
| 5 | 1:0.9:0.9 | 3:1 | 1:15 | 161 | purple |
| 6 | 0.9:1:0.9 | 3:1 | 1:20 | 138 | purple |
| 7 | 1:1:1 | 4:1 | 1:20 | 144 | purple |
| 8 | 0.9:0.9:0.9 | 3:1 | 1:20 | 139 | purple |
| 9 | 0.95:1.05:0.95 | 3.5:1 | 1:17 | 155 | purple |

Illustration:
¹the weight ratio of the combination of the white, red, and black solder proof inks to the curing agent
²the weight to volume ratio of the combination of the white, red, and black solder proof inks to the diluent

The colors of the solder proof ink compositions prepared in Examples 1-9 were purple, and the viscosities thereof were appropriate for printing circuit board.

In the above examples, the colors are determined by CMYK color model chart. When the weight ratio of the white, red, and black solder proof inks is 1:1:1, the mixture exhibits the color of No. 91; when the weight ratio of the white, red, and black solder proof inks varies in the range of 0.95-1.05:0.95-1.05:0.95-1.05, the mixture exhibits the colors of Nos. 90-92; when the weight ratio of the white, red, and black solder proof inks varies in the range of 0.9-1.1:0.9-1.1:0.9-1.1, the mixture exhibits the colors of Nos. 89-93.

### Comparison Examples

When studying the relations between the weight ratio of the white, red, and black solder proof inks and the color of the mixture thereof, the followings were found.

If decreasing the amount of the white solder proof ink or increasing the amount of the black solder proof ink, the color of the mixture became darkened and was close to the color of brown; if increasing the amount of the white solder proof ink, the color of the mixture became bluish; if decreasing the amount of the black solder proof ink, the color of the mixture became light red; if no red solder proof ink was added, the color of the mixture was greyish. Moreover, compared with the white and black solder proof inks, the amount alteration of the red solder proof ink had a less impact on the color of the mixture.

The specific ratios and colors are shown in Table 2.

TABLE 2

| Weight ratio of the | |
|---|---|
| white, red, and black | Color of the mixed |
| solder proof inks | solder proof ink |
| 0.1-0.5:1:1 | Brown |
| 1.5-2:1:1 | Blue |
| 1:1:0.1-0.5 | Light red |
| 1:1:1.5-2 | Orange to brown |
| 1:0:1 | Grey |

### Preparation of Purple Printed Circuit Board

The purple solder proof ink compositions as prepared in Examples 1-9 were applied to the preparation of printed circuit boards, comprising the following steps: pretreatment of the grinding plate, printing, procuring (75° C., 53 min), exposure, developing, and examination of the defects of printed circuit boards. Purple printed circuit boards with conformed quality were obtained.

While this disclosure has been described with references to certain embodiments thereof, it will be understood by those skilled in the art that various changes in form and details may be made therein without departing from the spirit and scope of the present application as defined by the appended claims. Such variations are intended to be within the scope of this present application. As such, the foregoing description of embodiments of the present application is not intended to be limiting. Rather, any limitations to the invention are presented in the following claims.

What is claimed is:

1. A purple solder proof ink composition for printing a circuit board, comprising a white solder proof ink, a red solder proof ink, and a black solder proof ink in a weight ratio of 0.9-1.1:0.9-1.1:0.9-1.1.

2. The purple solder proof ink composition of claim 1, wherein the purple solder proof ink composition exhibits a color of Nos. 89-93 in CMYK color model chart.

3. The purple solder proof ink composition of claim 1, wherein the white solder proof ink, the red solder proof ink, and the black solder proof ink are in a weight ratio of 0.95-1.05:0.95-1.05:0.95-1.05.

4. The purple solder proof ink composition of claim 3, wherein the purple solder proof ink composition exhibits a color of Nos. 90-92 in CMYK color model chart.

5. The purple solder proof ink composition of claim 1, wherein the white solder proof ink, the red solder proof ink, and the black solder proof ink are in a weight ratio of 1:1:1.

6. The purple solder proof ink composition of claim 5, wherein the purple solder proof ink composition exhibits a color of No. 91 in CMYK model color chart.

7. A process for preparing a purple printed circuit board, comprising:
(1) mixing a white solder proof ink, a red solder proof ink, and a black solder proof ink in a weight ratio of 0.9-1.1:0.9-1.1:0.9-1.1 to prepare a purple solder proof ink composition;
(2) adding at least one curing agent to the purple solder proof ink composition; and
(3) printing the purple solder proof ink composition comprising the white solder proof ink, the red solder proof ink, the black solder proof ink, and the at least one curing agent on at least one side of the circuit board.

8. The process of claim 7, further comprising adding at least one diluent to the purple solder proof ink composition before the printing step.

9. The process of claim 8, wherein the purple solder proof ink composition comprising the white solder proof ink, the red solder proof ink, the black solder proof ink, the at least one curing agent, and the at least one diluent was stirred until viscosity of the composition ranges from 130 to 180 dps before the printing step.

10. The process of claim 8, wherein the weight to volume ratio of the combination of the white solder proof ink, the red solder proof ink and the black solder proof ink to the at least one diluent is 1 kg:15-20 mL.

11. The process of claim 7, wherein the weight ratio of the combination of the white solder proof ink, the red solder proof ink, and the black solder proof ink to the at least one curing agent is 3-4:1.

12. A purple printed circuit board printed with a purple solder proof ink composition, wherein the purple solder proof ink composition comprises a white solder proof ink, a red solder proof ink, and a black solder proof ink in a weight ratio of 0.9-1.1:0.9-1.1:0.9-1.1.
